(19) United States
(12) Patent Application Publication
(10) Pub. No.: US 2019/0314959 A1
(43) Pub. Date: Oct. 17, 2019

(54) SWITCH DEVICE FOR RATCHET WRENCH

(71) Applicant: Yi-Fu Chen, Taichung City (TW)

(72) Inventor: Yi-Fu Chen, Taichung City (TW)

(21) Appl. No.: 15/953,515

(22) Filed: Apr. 16, 2018

(51) Int. Cl. B25B 13/46; B25B 23/00

(52) U.S. Cl. CPC B25B 13/463; B25B 23/0007

(57) ABSTRACT

A ratchet wrench includes a head in which a driving wheel and a pawl are received therein. The pawl includes teeth to be engaged with the driving wheel. A switch device includes a shank, a spring and a rod. The shank is rotatably received in a receiving hole in the head, and has a notch in which the spring and the rod are received. The rod is pushed by the spring and movably engaged with the recess in the rear side of the pawl. A protrusion is formed on the shank, and includes two shoulders formed on two ends thereof. The recess of the pawl includes contact ends. When the shank is pivoted, one of the two shoulders applies a force to the inner wall of the recess and one of the two contact ends to move the pawl to be engaged with the driving wheel.

### BACKGROUND OF THE INVENTION

### 1. Fields of the Invention

The present invention relates to a ratchet wrench, and more particularly, to a switch device for a ratchet wrench to accurately move the pawl to engage with the driving wheel.

### 2. Descriptions of Related Art

The conventional ratchet wrench is disclosed in FIGS. 8, 9 and 10, and includes a driving wheel 2 and a pawl 3 located in the head 1 of the ratchet wrench, and a switch device 4 is connected to the ratchet wrench to control the pawl 3 to be engaged with the driving wheel 2. The switch device 4 includes a switch member 5 which has a hole defined therein, and a spring 6 and a rod 7 are respectively located in the hole. The spring 6 is biased between the rod 7 and the inner end of the hole of the switch member 5. The rod 7 is movable along the recess 8 defined in the rear side of the pawl 3 so as to control the pawl 3 to move to engage the driving wheel 2, such that the ratcheting direction of the wrench is controlled and changed.

When pivoting the switch member 5, the force that spring 6 applies to the rod 7 is a key factor to accurately engage the pawl 3 with the driving wheel 2. If the force that the spring 6 applies to the pawl 3 from the rod 7 is too weak, as shown in FIGS. 8 to 10, the rod 7 cannot move the pawl 3 from left to right when pivoting the switch member 5. The rod 7 just moves along the recess 8 but does not move the pawl 3. The operation of the switch device 4 fails to change the ratcheting direction of the driving wheel 2 of the wrench. The ratcheting direction may be unexpectedly changed due to the unstable status of the pawl 3.

Therefore, when rotating the wrench, the pawl 3 cannot successfully drive and rotate the driving wheel 2, because the pawl 3 cannot provides a sufficient force to drive the driving wheel 2.

The present invention intends to provide a switch device for a ratchet wrench and is designed to eliminate the drawbacks mentioned above.

### SUMMARY OF THE INVENTION

The present invention relates to a ratchet wrench and comprises a head with a driving wheel and a pawl received in the head. The pawl has teeth defined in the front end thereof and a recess defined in the rear end thereof. The teeth of the pawl are movably engaged with the driving wheel. A switch device comprises a shank, a spring and a rod. The shank is rotatably received in a receiving hole in the head. The shank has a notch defined therein, the spring and the first end of the rod are received in the notch. The spring is biased between the inner end of the notch and the first end of the rod so that the second end of the rod is movably engaged with the recess of the pawl. The spring applies a force to the first end of the rod and the second end of the rod protrudes beyond the notch. A push portion comprises a protrusion formed on the shank, and two contact ends are formed on two ends of the recess of the pawl. The protrusion has two shoulders on two ends thereof and the shoulders protrude from outside of the shank. When the shank is pivoted, one of the two shoulders applies a force to the inner wall of the recess and one of the two contact ends to move the pawl.

The advantages of the present invention are that the force that the shank is pivoted is transferred to the pawl by one of the two shoulders applying a force to the inner wall of the recess and one of the two contact ends so as to move the pawl.

There are two forces to push the pawl when the shank is pivoted, one of the two forces is that the rod applies a force to the inner wall of the recess of the pawl, and the other one of the two forces is that the protrusion pushes the inner wall of the recess of the pawl and the contact end of the pawl. The two forces both are applied to the pawl to ensure that the pawl is moved to the correct position along with the pivotal movement of the shank, such that the ratcheting direction of the driving wheel is correctly changed.

When one of the two shoulders of the protrusion pushes the pawl, the other one of the two shoulders does not interfere the pawl to ensure that the force generated from the protrusion completely applies to the pawl.

The help from the protrusion and the rod to push the pawl reduces the compression force applied to the spring so that the spring can last longer.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the ratchet wrench of the present invention;

FIG. 2 is a cross sectional view to show the first operational status of the ratchet wrench of the present invention;

FIG. 3 is a cross sectional view to show the second operational status of the ratchet wrench of the present invention;

FIG. 4 is a cross sectional view to show the third operational status of the ratchet wrench of the present invention;

FIG. 5 is a cross sectional view to show the fourth operational status of the ratchet wrench or the present invention;

FIG. 6 is a cross sectional view to show the fifth operational status of the ratchet wrench of the present invention;

FIG. 7 is an enlarged cross sectional view of the circled portion in FIG. 1;

FIG. 8 is a cross sectional view to show the first operational status of a conventional ratchet wrench;

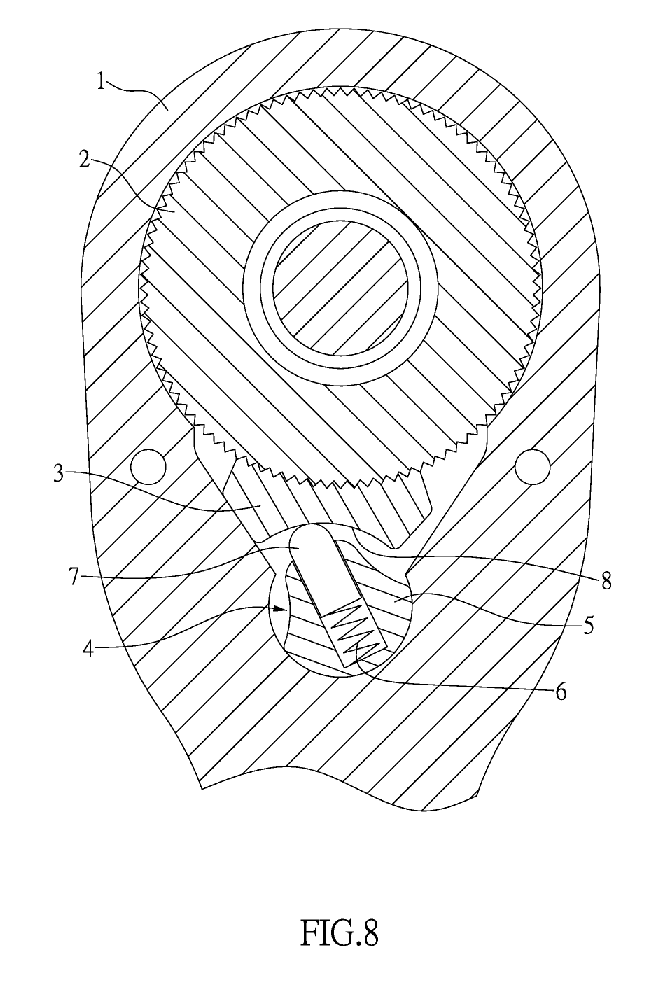

FIG. 9 is a cross sectional view to show the second operational status of the conventional ratchet wrench;

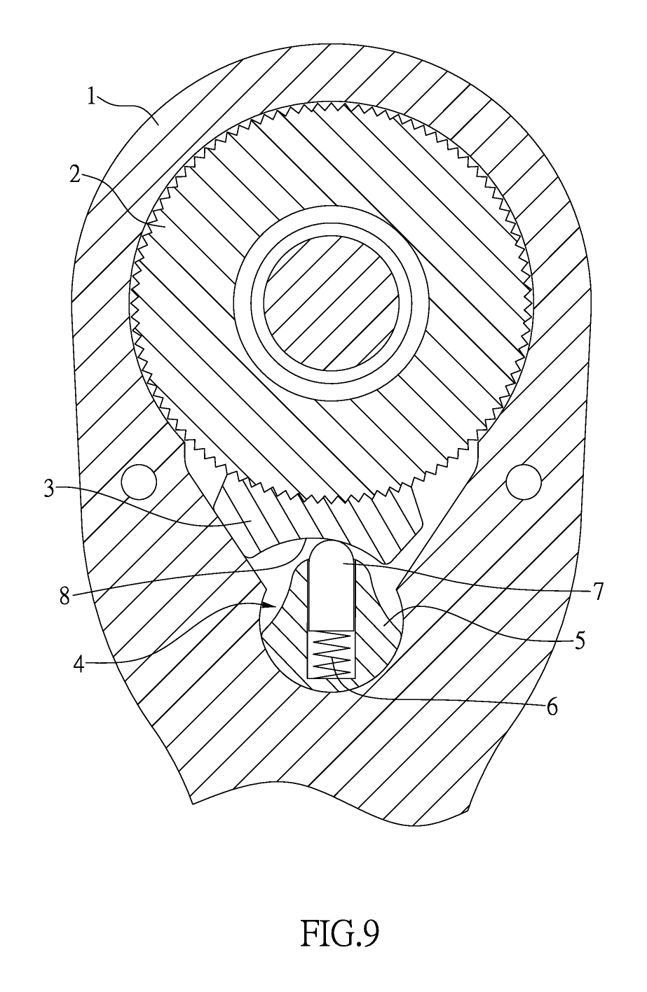

FIG. 10 is a cross sectional view to show the third operational status of the conventional ratchet wrench.

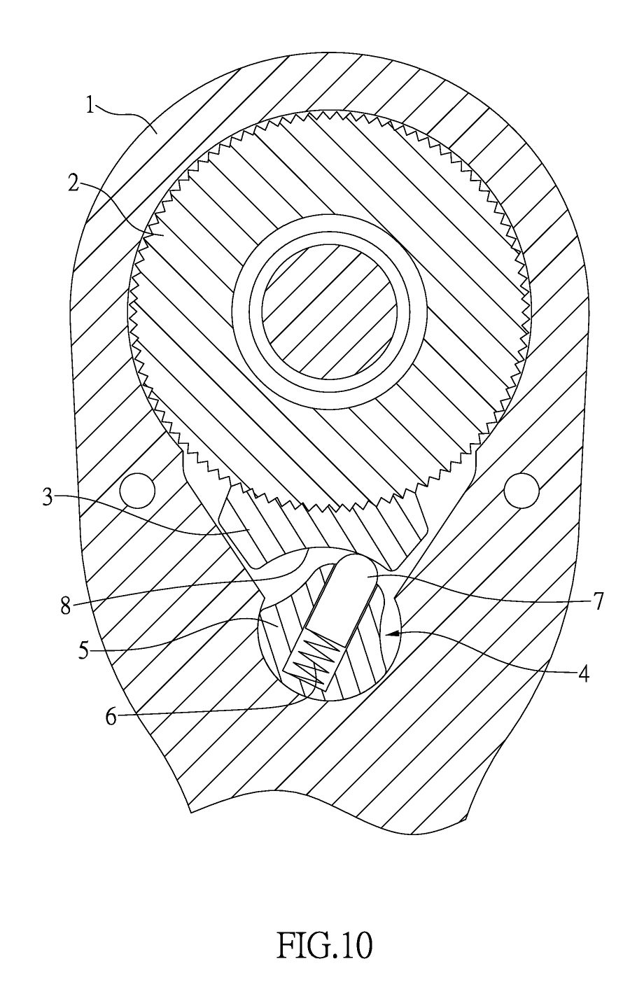

### DETAILED DESCRIPTION OF THE PREFERRED EMBODIMENT

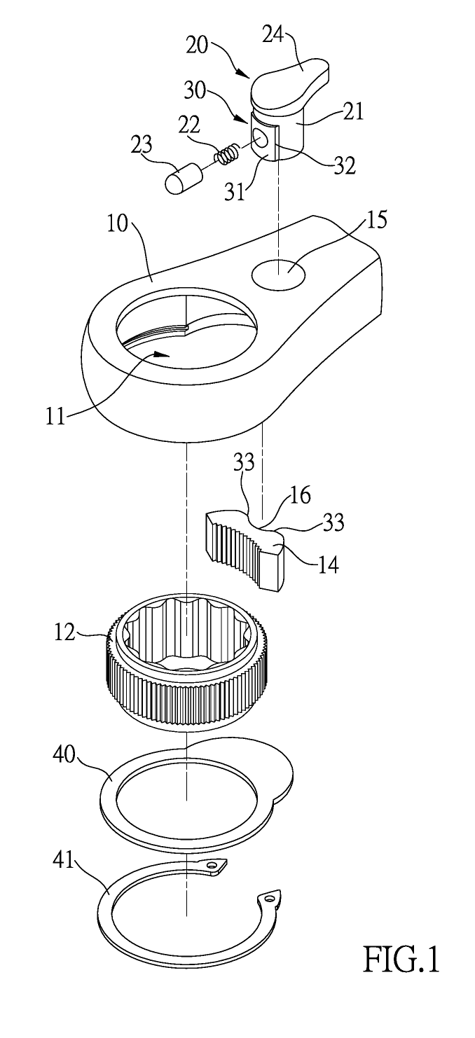

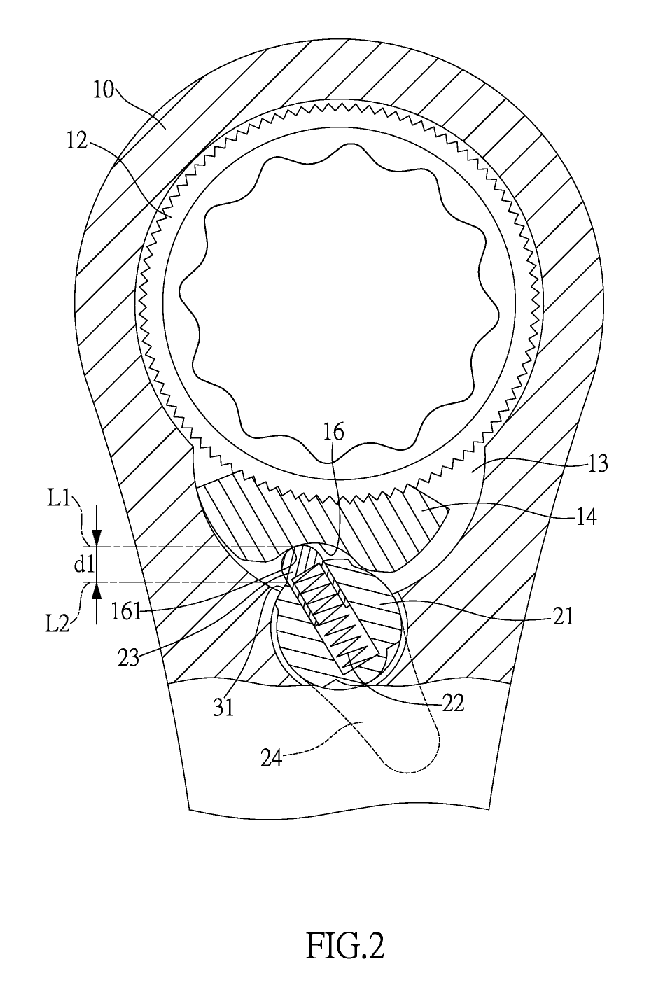

Referring to FIGS. 1 and 2, the ratchet wrench of the present invention comprises a head 10 having a through hole 11 defined therethrough, and a driving wheel 12 is rotatably received in the through hole 11. A room 13 is defined in the head 10 and communicates with the through hole 11. A pawl 14 is movably received in the room 13. A clip 41 and a ceiling ring 40 are used to seal the underside of the head 10 to restrict the driving wheel 12 and the pawl 14 from dropping out from the head 10. The pawl 14 includes teeth defined in the front end thereof and a recess 16 is defined in the rear end of the pawl 14. The teeth of the pawl 14 are movably engaged with the driving wheel 12.

A switch device 20 comprises a shank 21, a spring 22 and a rod 23. The shank 21 rotatably received in a receiving hole 15 in the head 10. The receiving hole 15 communicates with the room 15. The shank 21 has a notch defined therein, and the spring 22 and the first end of the rod 23 are received in the notch. The spring 22 is biased between the inner end of the notch and the first end of the rod 23 so that the second end of the rod 23 protrudes beyond the notch. A lever 24 is connected to the shank 21 and exposed on outside of the head 10 so that the users may shift the lever 24 to pivot the shank 21 as shown in FIGS. 2 to 6. The second end of the rod 23 is movably engaged with the recess 16 of the pawl 14. The spring 22 applies a force to the first end of the rod 23 to drive the pawl 14 to move.

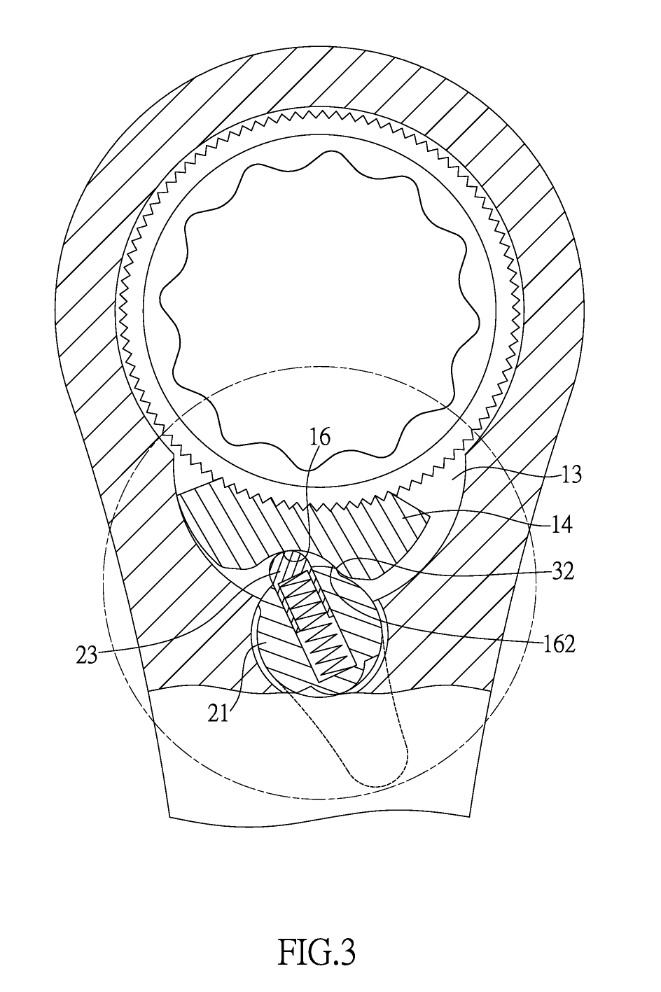

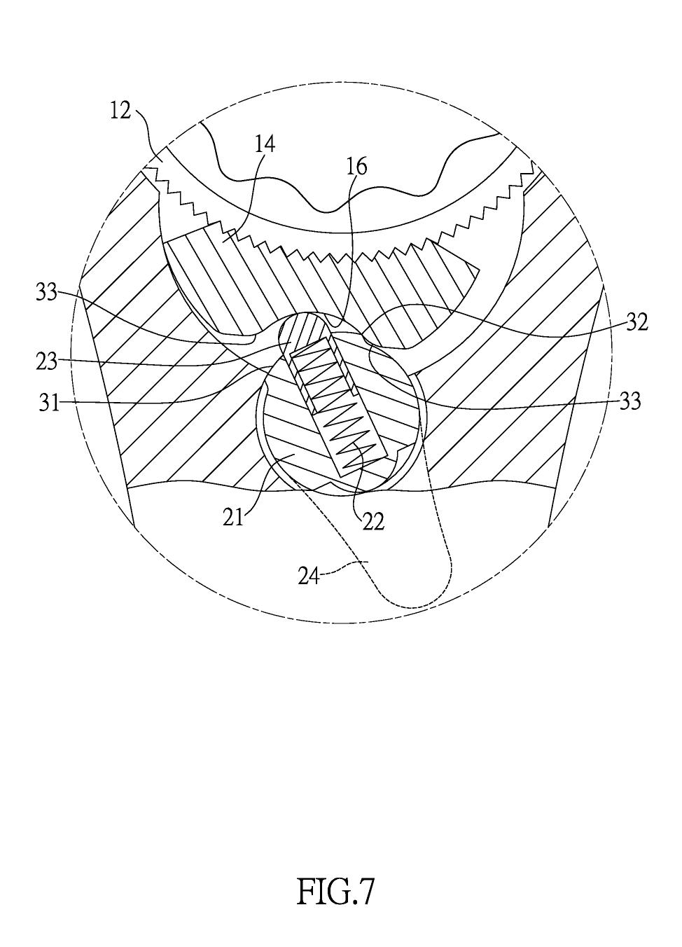

As shown in FIGS. 3 and 7, a push portion 30 comprises a protrusion 31 formed on outside of the shank 21, and two contact ends 33 are formed on two ends of the recess 16 of the pawl 14. The two contact ends 33 are two rounded and protruded contact ends 33. The protrusion 31 has two shoulders 32 on two ends thereof and the shoulders 32 protrude from outside of the shank 21.

As shown in FIGS. 2 to 6, when the shank 21 is pivoted, one of the two shoulders 32 applies a force to the inner wall of the recess 16 and one of the two contact ends 33 to move the pawl 14 to change the ratcheting directions or the ratchet wrench.

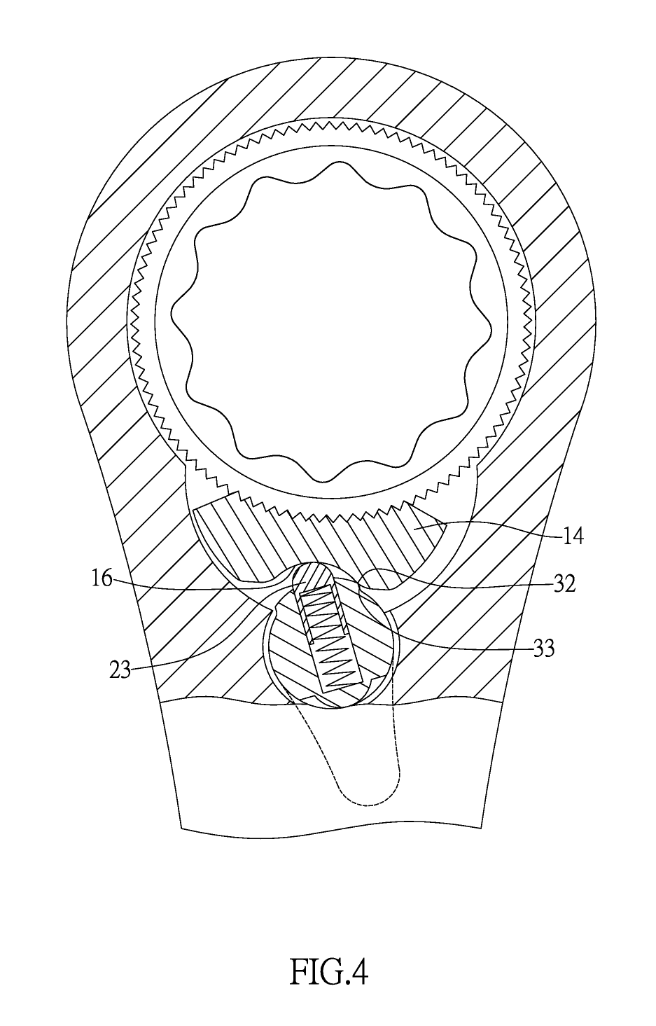

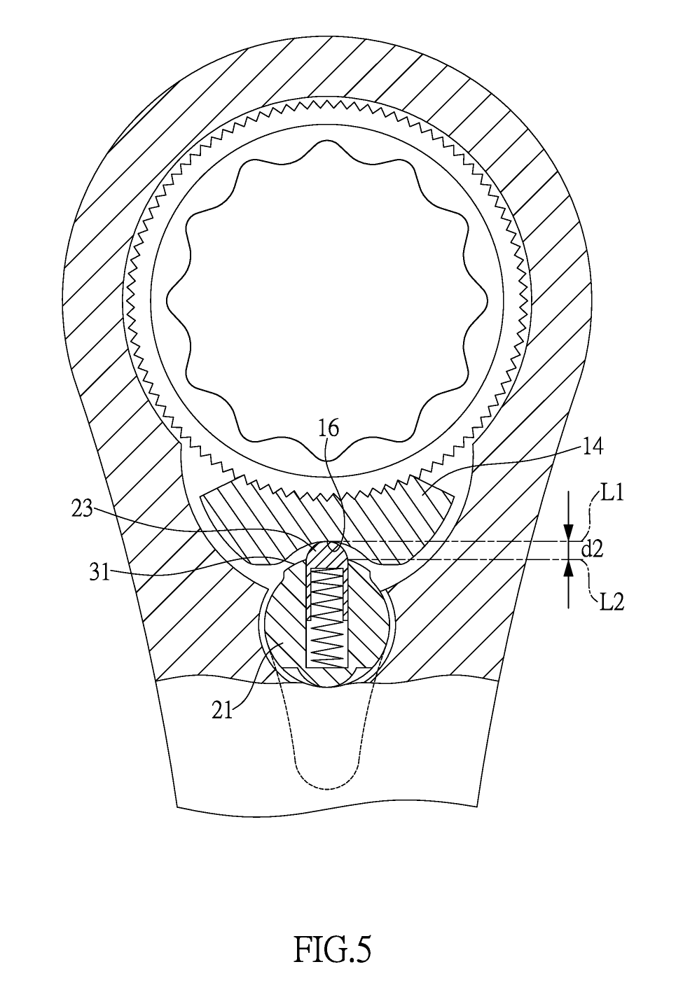

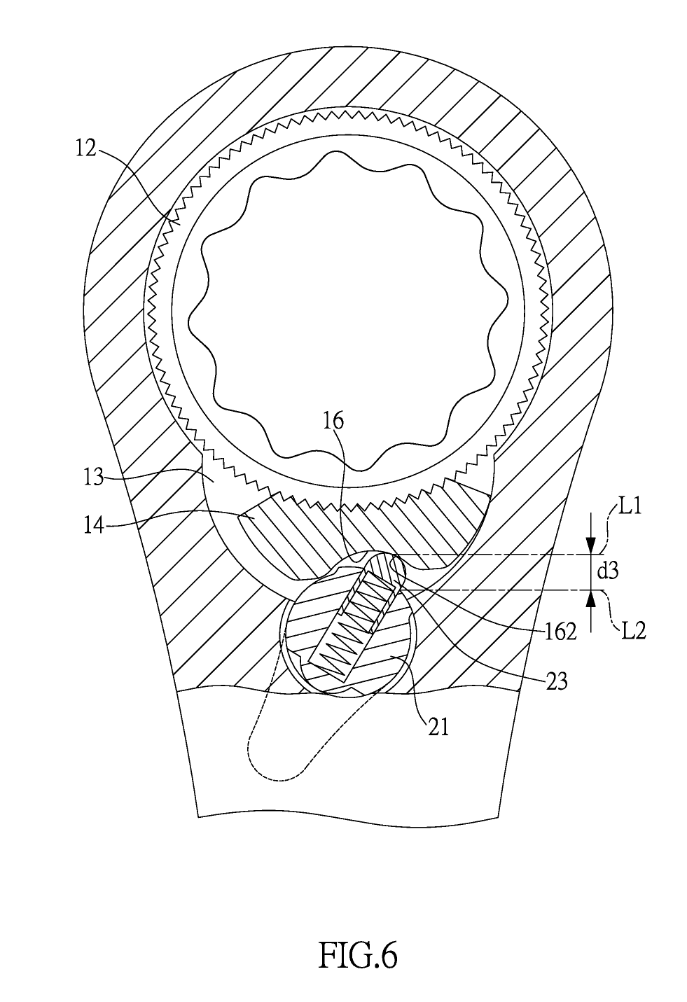

As shown in FIG. 2, when the pawl 14 is located at the left side of the room 13 and the rod 23 pushes the left inner wall 161 of the recess 16 of the pawl 14. The pawl 14 is engaged with the driving member 12 so that the wrench is rotatable clockwise to output torque. As shown in FIGS. 3 and 7, when the shank 21 is pivoted clockwise, the shoulder 32 on the right end of the protrusion 31 pushes the right inner wall 162 of the recess 16 of the pawl 14, so that the pawl 14 starts to move toward right. As shown in FIG. 4, the shank 21 is continuously pivoted clockwise, the rod 23 moves along the inner wall of the recess 16 of the pawl 14, and the shoulder 32 on the right end of the protrusion 31 pushes contact end 33 on the right end of the pawl 14, so that the pawl 14 moves toward right. As shown in FIG. 5, when rod 23 is moved to the middle of the recess 16 of the pawl 14, the protrusion 31 does not contact the pawl 14. As shown in FIG. 6, when the shank 21 is continuously pivoted clockwise, the rod 23 moves along the inner wall of the recess 16 of the paw 14 and pushes the right inner wall 162 of the inner wall of the recess 16 of the pawl 14. The pawl 14 contacts the right inner wall of the room 13 and is engaged with the driving member 12 so that the ratcheting direction is successfully changed.

There are two forces to push the pawl 14 when the shank 21 is pivoted. One of the two forces is that the rod 23 applies a force to the inner wall of the recess 16 of the pawl 14 by the spring 22. The other one of the two forces is that the protrusion 31 pushes the left and right inner walls 161, 162 of the recess 16 of the pawl 14 and the contact end 33 of the pawl 14. The two forces both are applied to the pawl 14 to ensure that the pawl 14 is moved to the correct position along with the pivotal movement of the shank 21, such that the ratcheting direction of the driving wheel 12 is correctly changed.

It is also noted that when the protrusion 31 pushes the pawl 14 by one of the two shoulders 32, the other shoulder 32 does not interfere the movement of the pawl 14 to ensure that the force that the protrusion 31 is completely used to move the pawl 14. The specific arrangement of the present invention shares the force to compress the spring as seen in the conventional ratchet wrenches, so that the life for the spring 22 of the present invention can be prolonged.

As shown in FIGS. 2, 5 and 6, when the shank 21 is pivoted and moves the pawl 14 from left to right, the distance between the top end of the protrusion 31 and the pawl 14 changes accordingly. As shown in FIG. 2, assume that a first horizontal line L1 passes the tip end of the rod 23, and a second horizontal line L2 passes the top end of the protrusion 31. The distance d1 is defined between the first horizontal line L1 and the second horizontal line L2. As shown in FIG. 5, the distance between the first horizontal line L1 and the second horizontal line L2 is defined as d2. As shown in FIG. 6, the distance between the first horizontal line L1 and the second horizontal line L2 is defined as d3. The changes between the d1, d2 and d3 show that the spring 22 is operated well, and this improves one of the shortcomings of the conventional ratchet wrench.

In addition, because the spring 22 is well operated, the rod 23 supports the pawl 14 precisely so that the position of the pawl 14 is well kept. In other words, the pawl 14 does not suddenly change by the reaction force transferred from the driving wheel 12, and this improves another one of the shortcomings of the conventional ratchet wrench.

While we have shown and described the embodiment in accordance with the present invention, it should be clear to those skilled in the art that further embodiments may be made without departing from the scope of the present invention.

What is claimed is:

1. A ratchet wrench comprising:
a head;
a driving wheel and a pawl received in the head, the pawl having teeth defined in a front end thereof and a recess defined in a rear end thereof, the teeth of the pawl movably engaged with the driving wheel;
a switch device having a shank, a spring and a rod, the shank rotatably received in a receiving hole in the head, the shank having a notch defined therein, the spring and a first end of the rod received in the notch, the spring biased between an inner end of the notch and the first end of the rod, a second end of the rod movably engaged with the recess of the pawl, the spring applying a force to the first end of the rod and the second end of the rod protruding beyond the notch, and
a push portion comprising a protrusion formed on the shank, and two contact ends formed on two ends of the recess of the pawl, the protrusion having two shoulders on two ends thereof and the shoulders protruding from outside of the shank, when the shank is pivoted, one of the two shoulders applies a force to an inner wall of the recess and one of the two contact ends to move the pawl.

2. A ratchet wrench comprising:
a head;
a driving wheel and a pawl received in the head, the pawl having teeth defined in a front end thereof and a recess defined in a rear end thereof, the teeth of the pawl movably engaged with the driving wheel;
a switch device having a shank, a spring and a rod, the shank rotatably received in a receiving hole in the head, the shank having a notch defined therein, the spring and a first end of the rod received in the notch, the spring biased between an inner end of the notch and the first end of the rod, a second end of the rod movably engaged with the recess of the pawl, the spring applying a force to the first end of the rod and the second end of the rod protruding beyond the notch, and
a push portion comprising a protrusion formed on the shank, the protrusion having two shoulders on two ends thereof and the shoulders protruding from outside of the shank, when the shank is pivoted, one of the two shoulders applies a force to an inner wall of the recess to move the pawl.
